(19) United States
(12) Patent Application Publication
(10) Pub. No.: US 2026/0115975 A1
(43) Pub. Date: Apr. 30, 2026

(54) DEVICE AND METHOD FOR MANUFACTURING A COMPONENT OF A TRANSFORMER SYSTEM

(71) Applicant: Hitachi Energy Ltd, Zürich (CH)

(72) Inventors: Robert SEKULA, Krakow (PL); Grzegorz KMITA, Giebultow (PL); Patricia GONZALEZ MARCO, Zaragoza (ES); Bartek WIELEBNOWSKI, Luino (IT); Krzysztof KASZA, Krakow (PL); Remigiusz NOWAK, Wettingen (CH); Pedro Jose MARQUES SALDAÑA, Zaragoza (ES)

(21) Appl. No.: 19/151,116

(22) PCT Filed: Feb. 16, 2023
(86) PCT No.: PCT/EP2023/053856

§ 371 Date: Jul. 25, 2025

(30) Foreign Application Priority Data
Feb. 10, 2023 (EP) 23382120.6

(51) Int. Cl. B29C 39/38; B29C 33/02; B29C 39/00; B29C 39/26; B29C 39/42; B29C 39/44; B29K 63/00; H01F 41/06; H01F 41/12

(52) U.S. Cl. CPC B29C 39/38; B29C 33/02; B29C 39/003; B29C 39/26; B29C 39/42; B29C 39/44; H01F 41/06; H01F 41/12; B29K 2063/00

(57) ABSTRACT

The present disclosure relates to a device for at least partially manufacturing at least one component of a transformer system. The device may include at least one mold configured to at least partially house at least one insulating material configured to at least partially insulate at least one conductor and at least one heating element configured to be coupled to the at least one mold and configured to heat the at least one insulating material to at least partially cure the at least one insulating material when the at least one insulating material is arranged at least partially in the at least one mold. The present disclosure also relates to a method for at least partially manufacturing at least one component of a transformer system.

### CROSS REFERENCE TO RELATED APPLICATIONS

This application is a 35 U.S.C. § 371 national stage application of PCT International Application No. PCT/EP2023/053856 filed on Feb. 16, 2023, which in turn claims priority to European Patent Application No. 23382120.6, filed Feb. 10, 2023, the disclosures and content of which are incorporated by reference herein in their entireties.

### BACKGROUND

Casting is widely used to manufacture a number of components in various technical fields. For instance, one or more components of a transformer system may be at least partially manufactured by one or more casting processes, e.g., epoxy reactive molding.

During a casting process, a casting material, which is in a substantially liquid state, is usually introduced into a mold. The mold may include one or more cavities which have one or more desired shapes and which receive the casting material. The casting material may then be solidified, e.g., cured, within the mold. The solidified part(s), which is/are also known as a casting, is/are ejected or broken out of the mold after solidification.

The casting material may be solidified actively by cooling and/or heating the casting material in the mold. For instance, curable material, such as resin and/or other thermosetting materials, may be used as a casting material. After the curable material has been introduced into the mold, the curable material may be at least partially cured, e.g., cross-linked, by applying heat to the curable material to at least partially solidify the curable material.

In the known prior art, the respective mold including the casting material is usually placed at least partially in a heated environment, e.g., within a convection oven, to at least partially cure the casting material.

In the known prior art, applying heat to the casting material is performed in a relatively inefficient manner. This may cause a relatively large consumption of energy which may increase the costs for manufacturing the respective components. In particular, energy prices are often subjected to changes, e.g., in response to changes and/or events in the economy and/or crises, which may result in increases in energy prices. In fact, recently, energy prices have risen relatively dramatically. Hence, due to the above-described relatively high energy consumption, the economics of manufacturing components by casting and curing is relatively vulnerable to rising energy prices. This may reduce the sustainability of casting and curing when using the devices and processes known from the prior art.

Moreover, the devices and processes known from the prior art may cause a relatively uneven curing of the casting material, e.g., due to differences in the convective heat transfer within the heated environment, e.g., which may happen when a number of components are randomly placed in the curing chamber. This may result in one or more deficiencies of the cast components, e.g., a variability and/or a dispersion of performance parameters and/or defects, such as cracks within the casting material.

The above aspects have not, or at least not sufficiently, been addressed in the prior art.

### SUMMARY

The present disclosure describes one or more aspects which address one or more of the above-identified drawbacks.

The present disclosure relates to a device according to a first aspect of the disclosure.

According to a second aspect, a method is described in the present disclosure.

The above and other aspects and their implementations are described in greater detail in the drawings, the descriptions, and the claims.

Various exemplary embodiments of the present disclosure disclosed herein are directed to providing features that will become readily apparent by reference to the following description when taken in conjunction with the accompanying drawings. In accordance with various embodiments, exemplary devices are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

In the following, exemplary embodiments of the disclosure will be described. It is noted that some aspects of any one of the described embodiments may also be found in some other embodiments unless otherwise stated or obvious. However, for increased intelligibility, each aspect will only be described in detail when first mentioned and any repeated description of the same aspect will be omitted.

The device according to the first aspect of the disclosure may be configured for at least partially manufacturing at least one component, in particular at least one component of a transformer system. The device may include at least one mold. The mold may be configured to at least partially house at least one insulating material, in particular at least one electrically insulating material. The at least one insulating material may be configured to at least partially insulate, in particular electrically insulate, at least one conductor, in particular at least one electrical conductor.

The at least one mold may include one or more cavities configured to at least partially and/or at least temporarily house or receive the at least one insulating material, in particular the at least one insulating material and the at least one conductor, in particular simultaneously.

The device may further include at least one heating element. The at least one heating element may be configured to be coupled to at least a section of the at least one mold. The at least one heating element may be configured to heat the at least one insulating material to at least partially cure the at least one insulating material, when the at least one insulating material is arranged at least partially in the at least one mold and the at least one heating element is operably coupled to at least a section of the at least one mold.

In the curing devices and processes known from the prior art, the respective mold including the casting material is placed at least partially in a heated environment, e.g., within a convection oven, to at least partially cure the casting material. In other words, the curing devices and processes known from the prior art rely, at least primarily, on heat convection via an atmospheric gas in the heated environment, e.g., air, to transfer heat to the casting material.

By contrast, configuring the at least one heating element to be coupled to at least a section of the at least one mold per the present disclosure may allow heat generated by the at least one heating element to be substantially conducted from the at least one heating element to the at least one insulating material, e.g., via one or more walls of the at least one mold. Hence, heat convection, as a resistance of heat transfer, is essentially eliminated from, or at least reduced in, the heat transfer of the heat generated by the at least one heating element to the at least one insulating material.

This may increase an efficiency and/or effectiveness of heat transfer from the at least one heating element to the at least one insulating material, e.g., compared with the known prior art solutions, in particular the prior art solutions which employ a convection oven. Furthermore, the at least one heating element described herein may reduce the overall thermal mass which is heated compared with the prior art, e.g., the material of an oven, and/or an air volume within the oven, which can be omitted per the present disclosure. Moreover, configuring the at least one heating element to be coupled to the at least one mold per the present disclosure may allow a more local, e.g., closer, and/or more direct application of heat to the at least one insulating material. This may reduce the energy consumption, and thus the costs, of the manufacturing process. For instance, the manufacturing of transformer system components, which may be relatively large and/or require a relatively large amount of insulating material, e.g., several hundreds of kilograms of insulating material, e.g., to cure the insulating material for the windings of the transformer system, may require relatively large ovens and/or a relatively large amount of heat when employing the known devices and processes for casting and curing said transformer system components. Thus, the device described herein may provide significant advantages compared with the prior art, as described above.

Moreover, the solution proposed herein may reduce a heat-up time of the device described herein, e.g., compared with the conventional oven system known from the prior art, e.g., by providing a more local and/or direct application of heat to the at least one insulating material and/or by reducing the thermal mass, as described above.

Configuring the at least one heating element to be coupled to the at least one mold may also allow an application of heat, via the at least one heating element, to be tailored and/or targeted more precisely compared with the known prior art solutions, e.g., convection ovens. For instance, this may allow an application of heat to be varied and/or individually configured. For instance, this may allow more heat to be applied to at least one first region than to at least one second region, e.g., by arranging and/or operating the heating element(s) accordingly. For instance, this may allow one or more sections of the at least one insulating material within the at least one mold, e.g., one or more sections of the at least one insulating material which are subjected to greater thermal losses during curing, e.g., one or more peripheral sections of the at least one insulating material within the at least one mold, to be provided with more heat, e.g., at a higher temperature and/or for a longer duration, than one or more other sections.

Moreover, configuring the at least one heating element to be coupled to the at least one mold may provide a more consistent, uniform, reliable and/or repeatable curing process, e.g., due to the closer and/or more direct application of heat to the at least one insulating material. Moreover, configuring the at least one heating element to be coupled to the at least one mold may provide a more controllable curing process e.g., by allowing a curing front of the insulating material in the mold to be controlled, which may allow residual stresses in the mold after the curing process to be controlled. This may enhance the quality of the cast components and/or may reduce deficiencies in the cast components.

In addition, the device described herein may be implemented into already available molds, e.g., molds which have been used in the solutions known from the prior art, e.g., in which the molds are placed in ovens for curing. Thus, the available molds may be retrofitted, e.g., by coupling the at least one heating element to the respective mold, to provide the device according to one of the configurations described herein.

The device described herein may be configured to completely cure the at least one insulating material. Alternatively, or additionally, the device described herein may be configured to only partially cure the at least one insulating material. For instance, the device described herein may be configured to partially cure the at least one insulating material such that the partially cured at least one insulating material may be removed in a partially cured state. In some embodiments, the partially cured at least one insulating material may then be completely cured, e.g., in a different process.

The at least one mold may be configured to at least partially house the at least one conductor and the at least one insulating material simultaneously, e.g., such that the at least one insulating material may be heated and at least partially cured, when the at least one conductor and the at least one insulating material are at least partially housed/received within the at least one mold. This may allow the at least one insulating material to be at least partially cured, i.e., solidified, in a state in which the at least one insulating material at least partially encompasses the at least one conductor such that the at least one insulating material may provide insulation, e.g., electrical insulation, to at least a section of the at least one conductor. This may allow the at least one insulating material and the at least one conductor to be removed from the at least one mold, after the at least one insulating material has been at least partially cured, as an (electrically) insulated conductor component, e.g., an (electrically) insulated winding of a transformer. Thus, (further) assembly of the at least one conductor and the at least one insulating material may not be required. Alternatively, the at least one insulating material may be cast and cured in the at least one mold, removed from the at least one mold, and may be assembled with the at least one conductor outside of the at least one mold, e.g., by inserting the at least one conductor at least partially into the at least one cured insulating material.

In other words, the at least one conductor and the at least one insulating material may form at least one (electrically) insulated conductor.

The device described herein may be configured to at least partially manufacture a number of different components of the transformer system. For instance, the device may be configured to at least partially manufacture one or more insulated windings of the transformer system. The one or more windings may include at least one electrical conductor, i.e., the at least one conductor described herein, and at least one electrically insulating material, i.e., the at least one insulating material described herein.

Alternatively, or additionally, the device described herein may be configured to at least partially manufacture a number of further components of the transformer system, e.g., any conducting, in particular electrically conducting, component which includes an insulating material, in particular an electrically insulating material.

The at least one heating element may be configured to be coupled to any section of the at least one mold. For instance, the at least one heating element may be configured to be coupled to at least one wall of the at least one mold, e.g., at least one wall of the at least one mold which at least partially defines one or more cavities configured to at least partially house or receive the at least one insulating material, in particular the at least one insulating material and the at least one conductor, in particular simultaneously, in particular on at least one side of the at least one wall which faces away from the one or more of the cavities and/or on at least one side of the at least one wall which faces towards the one or more of the cavities. For instance, the at least one heating element may be configured to be coupled to at least one side wall of the at least one mold. Alternatively, or additionally, the at least one heating element may be configured to be coupled to at least one top side and/or bottom side of the at least one mold, e.g., to one or more end panels of the at least one mold.

In particular, the at least one heating element may be configured to be coupled directly, i.e., without one or more intermediate components arranged between the at least one mold and the at least one heating element, and/or indirectly, i.e., with one or more intermediate components arranged between the at least one mold and the at least one heating element, to the at least one mold. The at least one heating element may be configured to be coupled to the at least one mold by various coupling mechanisms. For instance, the at least one heating element may be configured to be coupled to the at least one mold by at least one frictional or non-positive connection, at least one form-fitting or positive connection, and/or at least one adhesive connection.

The at least one heating element may be configured to be coupled, e.g., attached or fastened, to at least a section of an exterior and/or an interior of the at least one mold. Alternatively, or additionally, the at least one heating element may be configured to be coupled integrally with at least one wall of the at least one mold. In other words, the at least one heating element may be arranged at least partially within at least a section of the at least one wall of the at least one mold. For instance, the at least one wall of the at least one mold may be manufactured such that the at least one heating element may be arranged at least partially within the at least one wall. For instance, the at least one wall may be made from a plurality of wall layers, wherein the at least one heating element may be at least partially arranged between adjacent wall layers.

The transformer may be configured as any type of transformer. For instance, the transformer may be configured as a traction transformer, in particular for use on a railway vehicle, in particular to provide power to the railway vehicle. Alternatively, or additionally, the transformer may be configured as a dry-type transformer and/or a liquid-immersed transformer.

The at least one mold may have any shape and/or any size. In particular, the at least one mold may have a substantially cylindrical shape. However, the at least one mold may have a variety of different shapes.

The at least one mold may include a plurality of mold sections which are assembled and/or integrally formed. For instance, the at least one mold may include at least one outer mold section and at least one inner mold section. At least one cavity may be defined between the at least one outer mold section and the at least one inner mold section. The at least one cavity may be configured to house/receive the at least one insulating material.

The at least one mold, more specifically the at least one cavity, may be at least partially open to an environment. Alternatively, the at least one mold, more specifically the at least one cavity, may be closed from the environment.

The at least one insulating material may be in a substantially liquid state, when it is introduced into the at least one mold. The at least one insulating material may be pre-heated and/or partially pre-cured, when it is introduced into the at least one mold.

The at least one heating element may be configured to be coupled to at least one power source, e.g., an electrical power source.

The at least one mold, or at least a section of the at least one mold, may include at least one mold wall. The at least one heating element may be arranged to conduct heat to the at least one mold wall. As described above, this may allow heat generated by the at least one heating element to be conducted from the at least one heating element to the at least one insulating material via the at least one mold wall. Hence, heat convection, as a resistance of heat transfer, may be essentially eliminated from, or at least reduced in, the heat transfer from the at least one heating element to the at least one insulating material. The at least one heating element may be attached, directly or indirectly, to at least one surface of the at least one mold wall. The at least one mold wall may at least partially define one or more cavities of the at least one mold configured to receive/house the at least one insulating material.

In particular, the at least one heating element may be configured to be coupled, e.g., attached or fastened, to the at least one mold such that substantially no air gaps are present between the at least one heating element and the at least one mold, in particular between the at least one heating element and the at least one insulating material.

The at least one heating element may be configured to be arranged on at least one outer surface of the at least one mold wall. The term “outer surface” refers to a surface of the at least one mold wall which faces away from the at least one insulating material, when the at least one insulating material is arranged at least partially in the at least one mold. Alternatively, or additionally at least one of the heating element(s) may be configured to be arranged on at least one inner surface of the at least one mold wall. The term “inner surface” refers to a surface of the at least one mold wall which faces towards and/or which is in contact with the at least one insulating material, when the at least one insulating material is arranged at least partially in the at least one mold.

The at least one mold, or at least a section of the at least one mold, may include at least one outer mold wall and at least one inner mold wall which is arranged at least partially within the at least one outer mold wall. One or more cavities of the at least one mold, which are configured to house/receive the at least one insulating material, may be defined at least partially between the at least one outer mold wall and the at least one inner mold wall. The at least one heating element may be configured to be coupled, e.g., fastened, attached, or integrally coupled, to the at least one outer mold wall and/or to the at least one inner mold wall.

The at least one heating element may be configured as a flat-type heating element, in particular a strip heating element or a band heating element. For instance, the at least one heating element may be configured as a thick film heater or a thin film heater.

The at least one heating element may be configured to generate various amounts of heat. For instance, the at least one heating element may have a maximum output heating power of at least 1 kW, in particular at least 2 kW, in particular at least 3 kW, in particular at least 4 kW, in particular at least 5 kW, in particular at least 6 kW, in particular at least 7 kW, in particular at least 8 kW, in particular at least 9 kW, in particular at least 10 kW, or more. The at least one heating element may have a maximum output heating power density per surface of the at least one heating element of at least 500 W/m2, in particular at least 1 kW/m2, in particular at least 1.5 kW/m2, in particular at least 2 kW/m2, in particular at least 2.5 kW/m2, in particular at least 3 kW/m2, in particular at least 3.5 kW/m2, in particular at least 4 kW/m2, in particular at least 4.5 kW/m2, in particular at least 5 kW/m2, in particular at least 5.5 kW/m2, in particular at least 6 kW/m2, in particular at least 6.5 kW/m2, in particular at least 7 kW/m2, in particular at least 7.5 kW/m2, in particular at least 8 kW/m2, in particular at least 8.5 kW/m2, in particular at least 9 kW/m2, in particular at least 9.5 kW/m2, in particular at least 10 kW/m2, or more.

The at least one heating element, or an assembly of heating elements, may be deformable, e.g., flexible and/or bendable. This may allow the at least one heating element, or the assembly of heating elements, to be adapted to a shape of the at least one mold, e.g., to at least one contour, e.g., an inner contour and/or an outer contour, of the at least one mold.

The at least one heating element may be configured to be heated to a temperature of at least 150° C., in particular at least 175° C., in particular at least 200° C., in particular at least 225° C., in particular at least 250° C., in particular at least 275° C., in particular at least 300° C.

The device may further include at least one stabilizing element configured and arranged relative to the at least one heating element to store and/or distribute at least a portion of the heat generated by the at least one heating element. The at least one stabilizing element may provide a more even and/or more consistent application of heat generated by the heating element to the at least one insulating material. For the purpose of storing and/or distributing at least a portion of the heat generated by the at least one heating element, the at least one stabilizing element may be made of a material which has a relatively high heat capacity, e.g., ceramic, and/or a relatively high thermal conductivity. This may allow the at least one stabilizing element to store and/or distribute at least a portion of the heat generated by the at least one heating element relatively effectively and/or efficiently. However, the at least one stabilizing element may be made of various other materials, e.g., which have a relatively high heat capacity and/or a relatively high thermal conductivity.

The at least one stabilizing element may be connected to each other. For instance, the at least one stabilizing element may be arranged in contact with at least one of the at least one heating element. The at least one stabilizing element may be arranged, or configured to be arranged, on a side of the at least one heating element which faces away from the at least one insulating material, when the at least one insulating material is arranged in the at least one mold. Alternatively, or additionally, the at least one stabilizing element may be arranged, or configured to be arranged, on a side of the at least one heating element which faces towards the at least one insulating material, when the at least one insulating material is arranged in the at least one mold. In particular, the at least one stabilizing element may be arranged, or configured to be arranged, at least partially between the at least one heating element and the at least one insulating material, when the at least one insulating material is arranged in the at least one mold.

The device may further include at least one thermal insulating element configured to at least partially thermally insulate at least one or more sections of the at least one mold. This may reduce thermal losses which may provide a more effective and/or more efficient heating/curing of the at least one insulating material. The at least one thermal insulating element may be arranged at least partially at and/or on an exterior of the at least one mold. Alternatively, or additionally, the at least one thermal insulating element may be arranged at least partially at and/or on an interior of the at least one mold.

The device may include a plurality of heating elements, i.e., a plurality of the at least one heating element described above. The plurality of heating elements may be configured to heat a plurality of sections of the at least one insulating material, in particular individually, e.g., such that at least a first section of the plurality of sections may be heated by at least a first heating element of the plurality of heating elements and at least a second section of the plurality of sections may be heated by at least a second heating element of the plurality of heating elements. The first heating element(s) and the second heating element(s) may be configured to heat the first section(s) and the second section(s) of the at least one insulating material, respectively, to different temperatures and/or for different heating durations.

The device may further include at least one controller configured to adjust at least one temperature of at least one section of the at least one heating element and/or at least one temperature of at least one section of the least one insulating material and/or at least one heating duration of the at least one heating element. This may allow an application of heat, via the at least one heating element, to be tailored and/or targeted more precisely compared with the known prior art solutions, e.g., convection ovens. For instance, this may allow an application of heat to be varied and/or individually configured, as described above.

The at least one controller may be configured to control the at least one temperature and/or the at least one heating duration, in particular in a closed-loop manner. This may allow a more precise and/or targeted heating of the at least one insulating material, e.g., according to at least one target temperature and/or the at least one target heating duration.

The device may further include at least one temperature sensor configured to sense the at least one temperature and provide data relating to the at least one temperature to the at least one controller. The at least one temperature sensor may be configured as a thermocouple. However, any suitable temperature sensor may be employed.

The at least one temperature sensor may be integrated into the at least one heating element, e.g., as a single coherent unit including the at least one temperature sensor and the at least one heating element.

The at least one controller may be configured to adjust and/or control the at least one temperature and/or the at least one heating duration according to one or more temperatures profiles and/or one or more heating duration profiles, respectively. The one or more temperatures profiles and/or one or more heating duration profiles may define the at least one temperature and/or the at least one heating duration over time t. This may allow a more precise and/or targeted heating of the at least one insulating material, e.g., by customizing and/or adapting the at least one temperature and/or the at least one heating duration to the respective application. The device may include at least one data storage device configured to store the one or more temperatures profiles and/or one or more heating duration profiles and allow at least one of the one or more temperatures profiles and/or one or more heating duration profiles to be selected, e.g., manually, e.g., by a user, and/or automatically.

The one or more temperatures profiles and/or one or more heating duration profiles may be configured as predetermined and/or variable profiles.

The at least one controller and/or the at least one heating element may be configured to selectively heat a plurality of sections of the at least one insulating material. The at least one controller and/or the at least one heating element may be configured to selectively heat a plurality of sections of the insulating material independently from each other. The at least one controller and/or the at least one heating element may be configured to selectively heat a plurality of sections of the at least one insulating material such that the plurality of sections of the at least one insulating material are heated to different temperatures and/or for different heating durations.

The at least one controller and/or the at least one heating element may be configured to apply different amounts of heat and/or different heating durations to a plurality of sections of the at least one insulating material. For instance, one or more first sections of one heating element of the at last one heating element may be heated to one or more higher temperatures than one or more second sections of the one heating element of the at last one heating element. Alternatively, or additionally, a plurality of the at least one heating element may be provided and one or more first heating elements of the plurality of heating elements may be heated to higher temperatures than one or more second heating elements of the plurality of heating elements.

The at least one heating element may be configured to be powered electrically.

The at least one mold may be at least partially, in particular completely, made of metal. However, the at least one mold may be made of any suitable material(s), e.g., one or more composite materials, etc. The at least one mold may be made by one or more suitable manufacturing methods, e.g., including 3D-printing, etc. The at least one mold may be made of one or more materials which have a relatively high thermal conductivity, e.g., to provide a relatively low heat transfer resistance between the at least one heating element and the at least one insulating material.

The at least one mold, or at least a part of the at least one mold, may be configured for vacuum casting.

The at least one insulating material may include at least one resin, in particular at least one epoxy resin. However, the at least one insulating material may include any suitable curable and/or thermosetting material, e.g., liquid silicone rubbers, polyurethane, etc.

A method according to the second aspect of the present disclosure is described below. The features, configurations, and advantages described above with respect to the device according to the first aspect apply to the method accordingly.

The method may be configured for at least partially manufacturing at least one component of a transformer system. The method may be performed by the device according to the first aspect according to any configuration thereof described herein.

The method may include:
(a) arranging at least one insulating material, which is configured to at least partially insulate at least one conductor, at least partially in at least one mold.

The method may further include:
(b) heating the at least one insulating material by at least one heating element coupled to the at least one mold to at least partially cure the at least one insulating material, when the at least one insulating material is arranged at least partially in the at least one mold.

At least one temperature of the at least one heating element and/or at least one temperature of the least one insulating material and/or at least one heating duration of the at least one heating element may be adjusted by at least one controller.

The at least one temperature may be sensed by at least one temperature sensor. Data relating to the at least one temperature may be provided to the at least one controller.

The at least one temperature and/or the at least one heating duration may be adjusted by the at least one controller according to one or more temperatures profiles and/or one or more heating duration profiles, respectively.

A plurality of sections of the insulating material may be selectively heated, in particular independently from each other, in particular such that the plurality of sections of the insulating material may be heated to different temperatures and/or for different heating durations.

Different amounts of heat and/or different heating durations may be applied to a plurality of sections of the insulating material.

The following list of aspects provides alternative and/or further features of the disclosure:
1. A device for at least partially manufacturing at least one component, in particular at least one component of a transformer system, including:
   at least one mold configured to at least partially house at least one curable material, in particular at least one insulating material configured to at least partially insulate at least one conductor; and
   at least one heating element configured to be coupled to the at least one mold and configured to heat the at least one material to at least partially cure the at least one material, when the at least one material is arranged at least partially in the at least one mold.
2. The device according to aspect 1, wherein the at least one mold includes at least one mold wall and the at least one heating element is arranged to conduct heat to the at least one mold wall.
3. The device according to aspect 2, wherein the at least one heating element is configured to be arranged on at least one outer surface of the at least one mold wall.
4. The device according to any of the preceding aspects, wherein the at least one heating element is configured as a flat-type heating element, in particular a strip heating element or a band heating element.
5. The device according to any of the preceding aspects, further including at least one stabilizing element configured and arranged relative to the at least one heating element to store and/or distribute at least a portion of the heat generated by the at least one heating element, in particular wherein the at least one stabilizing element is made of at least one ceramic material.
6. The device according to any of the preceding aspects, further including at least one thermal insulating element configured to at least partially thermally insulate at least one or more sections of the at least one mold, in particular wherein the at least one thermal insulating element is arranged at least partially at and/or on an exterior of the at least mold.
7. The device according to any of the preceding aspects, including a plurality of the at least one heating element configured to heat a plurality of sections of the at least one curable material.
8. The device according to any of the preceding aspects, further including at least one controller configured to adjust at least one temperature of at least one portion of the at least one heating element and/or at least one temperature of the least one curable material and/or at least one heating duration of the at least one heating element.
9. The device according to aspect 8, wherein the at least one controller is configured to control the at least one temperature and/or the at least one heating duration, in particular in a closed-loop manner.
10. The device according to aspect 8 or 9, further including at least one temperature sensor configured to sense the at least one temperature and provide data relating to the at least one temperature to the at least one controller.
11. The device according to any of aspects 8 to 10, wherein the at least one controller is configured to adjust and/or control the at least one temperature and/or the at least one heating duration according to one or more temperatures profiles and/or one or more heating duration profiles, respectively.
12. The device according to any of aspects 8 to 11, wherein the at least one controller and/or the at least one heating element is/are configured to selectively heat a plurality of sections of the curable material, in particular independently from each other, in particular such that the plurality of sections of the curable material are heated to different temperatures and/or for different heating durations.
13. The device according to any of aspects 8 to 12, wherein the at least one controller and/or the at least one heating element is/are configured to apply different amounts of heat and/or different heating durations to a plurality of sections of the curable material.
14. The device according to any of the preceding aspects, wherein the at least one heating element is configured to be powered electrically.
15. The device according to any of the preceding aspects, wherein the at least one mold is at least partially, in particular completely, made of metal.
16. The device according to any of the preceding aspects, wherein the at least one mold is configured for vacuum casting.
17. The device according to any of the preceding aspects, wherein the at least one curable material includes at least one resin, in particular at least one epoxy resin.
18. A method for at least partially manufacturing at least one component of a transformer system, in particular by a device according to any of the preceding aspects, including:
   (c) arranging at least one curable material, in particular at least one insulating material which is configured to at least partially insulate at least one conductor, at least partially in at least one mold; and
   (d) heating the at least one curable material by at least one heating element coupled to the at least one mold to at least partially cure the at least one curable material, when the at least one curable material is arranged at least partially in the at least one mold.
19. The method according to aspect 18, wherein at least one temperature of the at least one heating element and/or at least one temperature of the least one curable material and/or at least one heating duration of the at least one heating element is/are adjusted by at least one controller.
20. The method according to aspect 19, wherein the at least one temperature is sensed by at least one temperature sensor and data relating to the at least one temperature is provided to the at least one controller.
21. The method according to aspect 19 or 20, wherein the at least one temperature and/or the at least one heating duration is/are adjusted by the at least one controller according to one or more temperatures profiles and/or one or more heating duration profiles, respectively.
22. The method according to any of aspects 18 to 21, wherein a plurality of sections of the at least one curable material are selectively heated, in particular independently from each other, in particular such that the plurality of sections of the at least one curable material are heated to different temperatures and/or for different heating durations.
23. The method according to any of aspects 18 to 22, wherein different amounts of heat and/or different heating durations are applied to a plurality of sections of the at least one curable material.

### BRIEF DESCRIPTION OF THE DRAWINGS

The subject-matter of the disclosure will be explained in more detail with reference to exemplary embodiments which are illustrated in the attached drawings.

FIG. 1 schematically shows, in a cross-sectional view, a device for at least partially manufacturing at least one component of a transformer system according to an embodiment of the present disclosure;

FIG. 2 schematically shows, in a longitudinal sectional view, a device for at least partially manufacturing at least one component of a transformer system according to a further embodiment of the present disclosure;

FIG. 3 schematically shows, in a cross-sectional view, a device for at least partially manufacturing at least one component of a transformer system according to a further embodiment of the present disclosure;

FIG. 4 schematically shows, in a cross-sectional view, a device for at least partially manufacturing at least one component of a transformer system according to a further embodiment of the present disclosure;

FIG. 5 schematically shows, in a longitudinal sectional view, a component which is at least partially manufactured by a device according to any configuration described herein.

### DETAILED DESCRIPTION

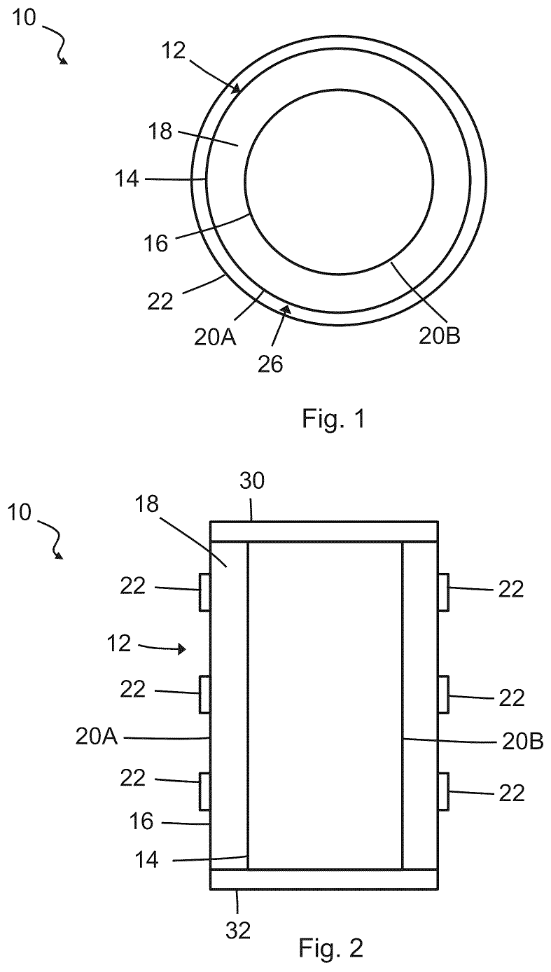

FIG. 1 schematically shows, in a cross-sectional view, a device 10 for at least partially manufacturing at least one component of a transformer system according to an embodiment of the present disclosure. The device 10 may include at least one mold 12 configured to at least partially house at least one insulating material configured to at least partially insulate at least one conductor.

The at least one mold 12 may include a plurality of mold sections which may be assembled or integrally formed. As shown in FIG. 1, the at least one mold 12 may include at least one outer mold section 14 and at least one inner mold section 16. The at least one inner mold section 16 may be arranged at least partially within the at least one outer mold section 14.

The at least one mold 12 may include at least one cavity 18 which may be defined between the at least one outer mold section 14 and the at least one inner mold section 16. The at least one cavity 18 may be configured to house/receive the at least one insulating material.

The at least one mold 12, e.g., the at least one outer mold section 14 and/or the at least one inner mold section 16, may include at least one mold wall 20A, 20B, e.g., at least one mold side wall 20A, 20B as shown in FIG. 1.

The device 10 may further include at least one heating element 22 configured to be coupled to the at least one mold 12. The at least one heating element 22 may be configured to heat the at least one insulating material to at least partially cure the at least one insulating material, when the at least one insulating material is arranged at least partially in the at least one mold 12 and the at least one heating element 22 is coupled to the at least one mold 12.

The at least one heating element 22 may be deformable, e.g., flexible and/or bendable. This may allow the at least one heating element 22 to be adapted to a shape of the at least one mold 12, e.g., to at least one contour, e.g., an inner contour and/or an outer contour, of the at least one mold 12. The at least one heating element 22 may be configured to be powered electrically. The at least one heating element 22 may be configured as a flat-type heating element, in particular a strip heating element or a band heating element.

The at least one heating element 22 may be arranged to conduct heat to the at least one mold wall 20A, 20B. For instance, the at least one heating element 22 may be attached, directly and/or indirectly, to the at least one mold wall 20A, 20B. For instance, the at least one heating element 22 may be configured to be arranged on at least one outer surface 26 of the mold wall 20A, as shown in FIG. 1 in an exemplary manner. The at least one heating element 22 may extend substantially about the entire circumference of the at least one core 12, as shown in FIG. 1. However, such a configuration is only exemplary. The at least one heating element 22 may extend about only a portion of the circumference of the at least one core 12. For instance, the device 10 may include a plurality of heating elements 22, i.e., a plurality of the at least one heating element 22 described above, which are distributed about at least a portion of the circumference of the at least one core 12 (see FIG. 4 and the corresponding description further below).

The device 10 may further include at least one thermal insulating element (not shown) configured to at least partially thermally insulate at least one or more sections of the at least one mold 12. This may reduce thermal losses which may provide a more effective and/or more efficient heating/curing of the at least one insulating material.

As shown in FIG. 2, the device 10 may include a plurality of heating elements 22, i.e., a plurality of the at least one heating element 22 described above with respect to FIG. 1. The heating elements 22 may be arranged at different locations. In particular, the heating elements 22 may be distributed, e.g., such that the heating elements 22 are spaced from each other.

As shown in FIG. 2, the at least one mold 12 may include at least one top member 30 and/or at least one bottom member 32 which may at least partially define or delimit the at least one cavity 18.

As shown in the Figs., the at least one heating element 22 may be coupled, or configured to be coupled, to at least one mold side wall 20A, 20B. Alternatively, or additionally, at least one of the at least one heating element 22 may be coupled, or configured to be coupled, to the at least one top member 30 and/or the at least one bottom member 32.

As shown, e.g., in FIGS. 1 and 2, the at least one heating element 22 may be coupled, or configured to be coupled, to the at least mold 12 at and/or on an exterior of the at least one mold 12. For instance, the at least one heating element 22 may be coupled, or configured to be coupled, to the at least one mold 12 on a side of the at least one wall 20A, 20B of the at least one mold 12 which faces away from the at least one cavity 18 and/or on a side of the at least one wall 20A, 20B of the at least one mold 12 which faces towards the at least one cavity 18.

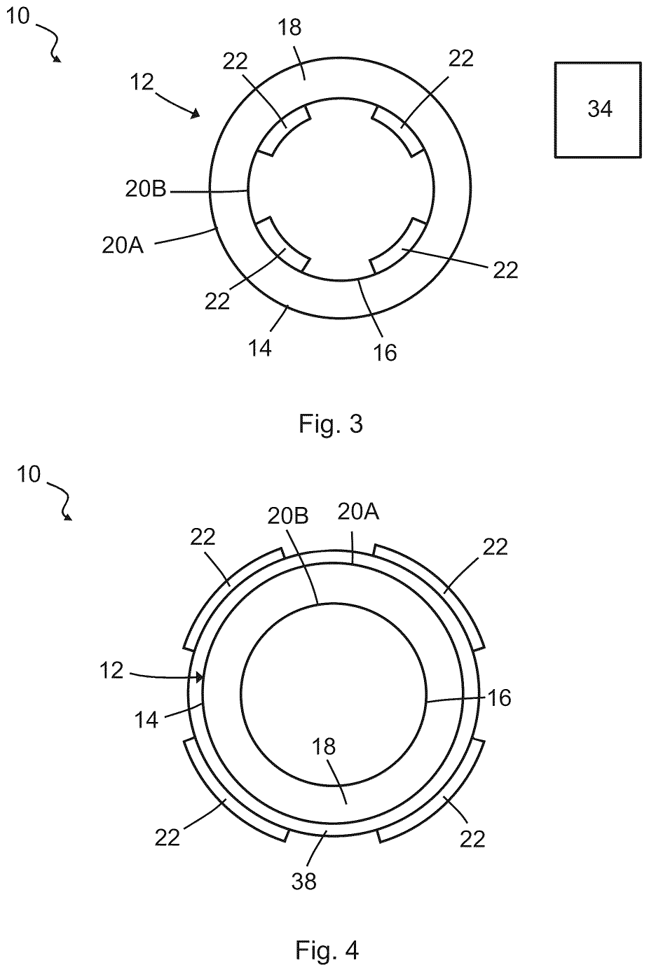

Alternatively, or additionally, the at least one heating element 22 may be coupled, or configured to be coupled, to the at least one mold 12 at and/or on an interior of the at least one mold 12, as shown in FIG. 3.

Alternatively, or additionally, the at least one heating element 22 may be configured to be coupled integrally with the at least one wall 20A, 20B of the at least one mold 12. In other words, the at least one heating element 22 may be arranged within at least a section of the at least one wall 20A, 20B of the at least one mold 12, which is not specifically shown in the Figs. For instance, the at least one wall 20A, 20B of the at least one mold 12 may be manufactured such that the at least one heating element 22 is arranged within the at least one wall 20A, 20B. For instance, the at least one wall 20A, 20B may be made from a plurality of wall layers, wherein the at least one heating element 22 may be at least partially arranged between adjacent wall layers of the at least one wall 20A, 20B.

The device 10 may further include at least one controller 34 configured to adjust at least one temperature of at least one section of the at least one heating element 22 and/or at least one temperature of at least one section of the least one insulating material and/or at least one heating duration of the at least one heating element 22. The at least one controller 34 may be communicatively connected with the at least one heating element 22, e.g., wirelessly and/or via a hard connection.

The at least one controller 34 may be configured to control each heating element 22 individually and/or collectively. The at least one controller 34 and/or the at least one heating element 22 may be configured to heat one or more first sections of one heating element 22 to one or more higher temperatures than one or more second sections of the one heating element 22. Alternatively, or additionally, the at least one controller 34 and/or the plurality of heating elements 22 may be configured such that one or more first heating elements of the plurality of heating elements 22 may be heated to higher temperatures than one or more second heating elements of the plurality of heating elements 22. Alternatively, the device 10 may include a plurality of controllers 34, wherein each controller 34 may be configured to control one or more different heating elements of the plurality of heating elements 22.

The at least one controller 34 may be configured to adjust and/or control the at least one temperature and/or the at least one heating duration according to one or more temperatures profiles and/or one or more heating duration profiles, respectively. The one or more temperatures profiles and/or one or more heating duration profiles may define the at least one temperature and/or the at least one heating duration over time t. This may allow a more precise and/or targeted heating of the at least one insulating material, e.g., by customizing and/or adapting the at least one temperature and/or the at least one heating duration to the respective application. The device 10, e.g., the at least one controller 34, may include at least one data storage device configured to store the one or more temperatures profiles and/or one or more heating duration profiles and allow at least one of the one or more temperatures profiles and/or one or more heating duration profiles to be selected, e.g., manually, e.g., by a user, and/or automatically.

The device 10 may further include at least one stabilizing element 38 configured and arranged relative to the at least one heating element 22 to store and/or distribute at least a portion of the heat generated by the at least one heating element 22, as shown in FIG. 4. The at least one stabilizing element 38 may provide a more even and/or more consistent application of heat generated by the at least one heating element 22 to the at least one insulating material. For the purpose of storing and/or distributing at least a portion of the heat generated by the at least one heating element, the at least one stabilizing element 38 may be made of a material which has a relatively high heat capacity, e.g., ceramic, and/or a relatively high thermal conductivity. This may allow the at least one stabilizing element 38 to store and/or distribute at least a portion of the heat generated by the at least one heating element 22 relatively effectively and/or efficiently. However, the at least one stabilizing element 38 may be made of various other materials, e.g., which have a relatively high heat capacity and/or a relatively high thermal conductivity.

The features of the embodiments of FIGS. 1 to 4 may also be combined in various configurations. For instance, the device 10 may include a plurality of heating elements 22, wherein at least one of the plurality of heating elements 22 may be coupled, or configured to be coupled, to the at least mold 12 at and/or on an exterior of the at least one mold 12 and at least one of the plurality of heating elements 22 may be coupled, or configured to be coupled, to the at least mold 12 at and/or on an interior of the at least one mold 12.

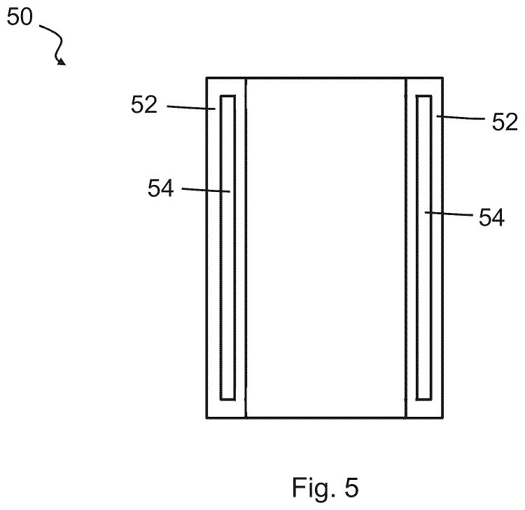

FIG. 5 schematically shows, in a longitudinal sectional view, a component 50 which was at least partially manufactured by the device 10 according to any of the configurations described herein, e.g., as shown in any of FIGS. 1 to 4. The component 50 may include at least one insulating material 52, e.g., the at least one insulating material described above, which may be received/housed in the at least one mold 12 of the device 10, as described above. The component 50 may further include at least one conductor 54 which may also be received/housed in at least one mold 12 of the device 10, as described above. In other words, the at least one mold 12 may be configured to at least partially and/or at least temporarily house or receive the at least one insulating material 52 and the at least one conductor 54 simultaneously. The at least one insulating material 52 may be, or at least include, at least one resin, in particular at least one epoxy resin.

The at least one insulating material 52 may be introduced into the at least one mold 12, e.g., into the at least one cavity 18, in a substantially liquid state. The at least one conductor 54 may be in a substantially solid state, when the at least one conductor 54 is introduced into the at least one mold 12. After the at least one insulating material 52 and the at least one conductor 54 have been introduced into the at least one mold 12, the at least one insulating material 52 may be at least partially cured by heat generated by the at least one heating element 22 of the device 10 to at least partially solidify the at least one insulating material 52.

This may allow the at least one insulating material 52 to be at least partially cured, i.e., solidified, in a state in which the at least one insulating material 52 at least partially encompasses the at least one conductor 54 such that the at least one insulating material 52 may provide insulation, e.g., electrical insulation, to at least a section of the at least one conductor 54, as shown in FIG. 5. In other words, the at least one conductor 54 and the at least one insulating material 52 may form at least one (electrically) insulated conductor. The at least one conductor 54 may be configured to be connected to at least one voltage power and/or at least one load, e.g., via at least one connector (not shown).

Once the at least one insulating material 52 has been at least partially cured, the at least partially cured at least one insulating material 52 may be removed from the at least one mold 12.

The device 10 described herein may be configured to at least partially manufacture a number of different components of a transformer system. For instance, the device 10 may be configured to at least partially manufacture one or more insulated windings of the transformer system. For instance, the at least conductor 54 may be at least one winding wound about at least one winding axis by one or more turns. The winding may be introduced into the at least one mold 12 in a wound state.

Alternatively, or additionally, the device 10 described herein may be configured to at least partially manufacture a number of further components of a transformer system, e.g., any conducting, particularly electrically conducting, component which includes an insulating material, particularly an electrically insulating material.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A device for at least partially manufacturing at least one component of a transformer system, including:
at least one mold configured to at least partially house at least one insulating material configured to at least partially insulate at least one conductor and
at least one heating element configured to be coupled to the at least one mold and configured to heat the at least one insulating material to at least partially cure the at least one insulating material, when the at least one insulating material is arranged at least partially in the at least one mold, wherein the at least one heating element is flexible and/or bendable.

2. The device according to claim 1, wherein the at least one mold includes at least one mold wall and the at least one heating element is arranged to conduct heat to the at least one mold wall.

3. The device according to claim 2, wherein the at least one heating element is configured to be arranged on at least one outer surface of the at least one mold wall.

4. The device according to claim 1, wherein the at least one heating element is configured as a flat-type heating element, in particular a strip heating element or a band heating element.

5. The device according to claim 1, further including at least one stabilizing element configured and arranged relative to the at least one heating element to store and/or distribute at least a portion of the heat generated by the at least one heating element, in particular wherein the at least one stabilizing element is made of at least one ceramic material.

6. The device according to claim 1, including a plurality of the at least one heating element configured to heat a plurality of sections of the at least one insulating material.

7. The device according to claim 1, further including at least one controller configured to adjust at least one temperature of at least one portion of the at least one heating element and/or at least one temperature of the least one insulating material and/or at least one heating duration of the at least one heating element.

8. The device according to claim 7, wherein the at least one controller is configured to adjust and/or control the at least one temperature and/or the at least one heating duration according to one or more temperatures profiles and/or one or more heating duration profiles, respectively.

9. The device according to claim 7, wherein the at least one controller and/or the at least one heating element is/are configured to selectively heat a plurality of sections of the insulating material, in particular independently from each other, in particular such that the plurality of sections of the insulating material are heated to different temperatures and/or for different heating durations.

10. The device according to claim 7, wherein the at least one controller and/or the at least one heating element is/are configured to apply different amounts of heat and/or different heating durations to a plurality of sections of the insulating material.

11. The device according to claim 1, wherein the at least one heating element is configured to be powered electrically.

12. A method for at least partially manufacturing at least one component of a transformer system by a device according to claim 1, including:
(a) arranging at least one insulating material, which is configured to at least partially insulate at least one conductor, at least partially in at least one mold; and
(b) heating the at least one insulating material by at least one heating element coupled to the at least one mold to at least partially cure the at least one insulating material, when the at least one insulating material is arranged at least partially in the at least one mold, wherein the at least one heating element is flexible and/or bendable.

13. The method according to claim 12, wherein at least one temperature of the at least one heating element and/or at least one temperature of the least one insulating material and/or at least one heating duration of the at least one heating element is/are adjusted by at least one controller.

14. The method according to claim 13, wherein the at least one temperature and/or the at least one heating duration is/are adjusted by the at least one controller according to one or more temperatures profiles and/or one or more heating duration profiles, respectively.

15. The method according to claim 12, wherein a plurality of sections of the insulating material are selectively heated, in particular independently from each other, in particular such that the plurality of sections of the insulating material are heated to different temperatures and/or for different heating durations.
